(19) United States
(12) Patent Application Publication
(10) Pub. No.: US 2012/0209434 A1
(43) Pub. Date: Aug. 16, 2012

(54) METHOD FOR OPERATING DIFFERENTIAL PRESSURE WATER ELECTROLYSIS APPARATUS

(75) Inventors: Daisuke Kurashina, Wako (JP); Masanori Okabe, Wako (JP); Jun Takeuchi, Wako (JP)

(73) Assignee: HONDA MOTOR CO., LTD., Tokyo (JP)

(21) Appl. No.: 13/354,330

(22) Filed: Jan. 20, 2012

(30) Foreign Application Priority Data
Feb. 15, 2011 (JP) 2011-029502

(51) Int. Cl. G06F 17/00

(52) U.S. Cl. 700/273

(57) ABSTRACT

A method for operating a differential pressure water electrolysis apparatus includes calculating in advance values of an electric current required for an electrolysis of water in response to pressures of a cathode-side electrolysis chamber, detecting a pressure of the cathode-side electrolysis chamber when the electrolysis of water is not carried out, determining whether or not the electrolysis of water is to be started, and starting the electrolysis of water with an electric current having a value equal to or higher than a value which is calculated in advance in the calculating of the values of the electric current and which corresponds to a detected pressure of the cathode-side electrolysis chamber when it is determined that the electrolysis of water is to be started.

### CROSS-REFERENCE TO RELATED APPLICATIONS

The present application claims priority under 35 U.S.C. §119 to Japanese Patent Application No. 2011-029502 filed in the Japan Patent Office on Feb. 15, 2011, entitled “Method for Operating Differential Pressure Water Electrolysis Apparatus”. The contents of this application are incorporated herein by reference in their entirety.

### BACKGROUND OF THE INVENTION

1. Field of the Invention

The present invention relates to a method for operating a differential pressure water electrolysis apparatus.

2. Discussion of the Background

For example, a solid polymer electrolyte fuel cell generates direct-current electric energy by supplying a fuel gas (gas mainly containing hydrogen, for example, hydrogen gas) to an anode-side electrode and an oxidizer gas (gas mainly containing oxygen, for example, air) to a cathode-side electrode.

Typically, a water electrolysis apparatus is used to generate hydrogen gas for use as a fuel gas. The water electrolysis apparatus uses a solid polymer electrolyte membrane (ion-exchange membrane) for decomposing water to generate hydrogen (and oxygen). Electrode catalyst layers are provided on both surfaces of the solid polymer electrolyte membrane to form an electrolyte membrane/electrode assembly. Furthermore, current collectors are disposed on both sides of the electrolyte membrane/electrode assembly to form a unit.

A plurality of the units is then being stacked together. In this stack, a voltage is applied across both ends in the stacking direction and water is supplied to the anode side. As a result, water is decomposed and hydrogen ions (protons) are generated at the anode-side of the electrolyte membrane/electrode assembly. The hydrogen ions permeate through the solid polymer electrolyte membrane, move to the cathode-side, and combine with electrons to generate hydrogen. At the anode-side, oxygen generated together with the hydrogen ions is discharged from the unit accompanied by excess water.

Water electrolysis apparatuses of this type employ a high pressure hydrogen generator (differential pressure water electrolysis apparatus) producing high pressure hydrogen (typically, 1 MPa or more) at the cathode-side. The high pressure hydrogen generator may include, for example, as disclosed in Japanese Unexamined Patent Application Publication No. 2006-70322, a solid polymer membrane, a cathode current collector and an anode current collector provided on both sides of the solid polymer membrane so as to face each other, separators stacked on the respective current collectors, and flow paths provided in the respective separators to expose the corresponding current collectors.

Water is supplied to a flow path of the anode-side separator and current is applied to each of the current collectors, thereby electrically decomposing the water supplied through the flow path of the anode-side separator, producing high pressure hydrogen gas in the flow path of the cathode-side separator. There is provided a pressuring device that presses the cathode current collector against the solid polymer membrane so as to come in contact with each other.

Since the pressuring device presses the cathode current collector against the solid polymer membrane so as to come in contact with each other, no gap would be created between the solid polymer membrane and the cathode current collector when the cathode-side become a high pressure, making it possible to prevent an increase in the contact resistance.

In the above mentioned high pressure hydrogen generator, the flow path of the cathode-side separator is filled with the high pressure hydrogen while the flow path of the anode-side separator, which sandwiches the solid polymer membrane with the cathode-side separator, is filled with normal pressure water and oxygen. Accordingly, at the end of operation (end of supplying hydrogen generated), it is necessary to remove a pressure difference between two sides of the solid polymer membrane to protect the solid polymer membrane.

Typically, the hydrogen pressure is reduced down close to the normal pressure by releasing the pressure of hydrogen filling the cathode-side flow path by force after setting the power supply to each of the current collectors to zero to stop the electrolysis of water.

### SUMMARY OF THE INVENTION

According to one aspect of the present invention, a method is for operating a differential pressure water electrolysis apparatus. In the differential pressure water electrolysis apparatus, an electrolyte membrane is provided with current collectors at both sides of the electrolyte membrane, and an electrolysis voltage is applied between the current collectors to generate oxygen at an anode-side electrolysis chamber and hydrogen with a pressure higher than a normal pressure at a cathode-side electrolysis chamber by electrolysis of water. The method includes: calculating in advance values of an electric current required for the electrolysis of water in response to pressures of the cathode-side electrolysis chamber; detecting a pressure of the cathode-side electrolysis chamber when the electrolysis of water is not carried out; determining whether or not the electrolysis of water is to be started; and starting the electrolysis of water with an electric current having a value equal to or higher than a value which is calculated in advance in the calculating of the values of the electric current and which corresponds to a detected pressure of the cathode-side electrolysis chamber when it is determined that the electrolysis of water is to be started.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a drawing illustrating a schematic configuration of a differential pressure water electrolysis apparatus to which an operating method according to an embodiment of the present invention is applied.

FIG. 2 is an exploded perspective view illustrating a unit cell included in the differential pressure water electrolysis apparatus.

FIG. 3 is a flow chart illustrating the operation method.

FIG. 4 is a drawing illustrating typical steps of pressure release, preparation and pressure build-up.

FIG. 5 is a drawing illustrating relations between a pressure difference and an amount of cross-leak and between a pressure difference and an electric current for the cross-leak prevention.

FIG. 6 is a drawing illustrating a pressure build-up step, which starts in the middle of a pressure release step, according to an embodiment of the present invention.

### DESCRIPTION OF THE EMBODIMENTS

The embodiments will now be described with reference to the accompanying drawings, wherein like reference numerals designate corresponding or identical elements throughout the various drawings.

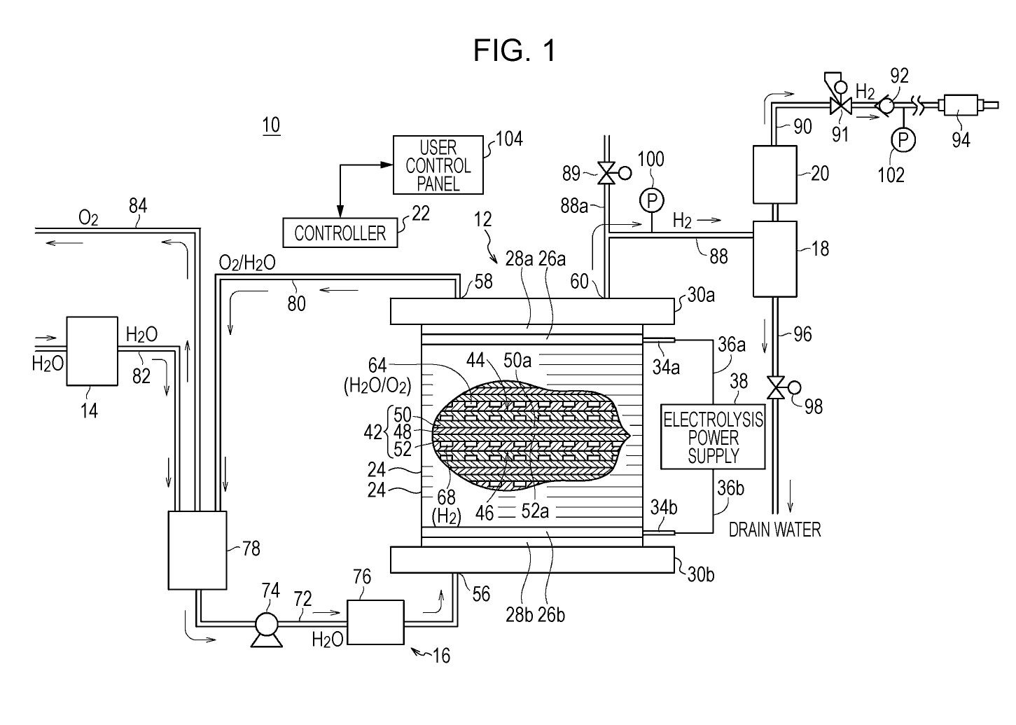

As illustrated in FIG. 1, a differential pressure water electrolysis apparatus 10, to which an operating method according to an embodiment of the present invention is applied, may be used, for example, as a small hydrogen generator for home use.

The differential pressure water electrolysis apparatus 10 includes: a water electrolysis unit 12 that generates high pressure hydrogen (hydrogen with a pressure higher than the normal pressure) by electrolysis of pure water; a water circulation unit 16 that receives a supply of pure water generated from tap water by a pure water supply unit 14, supplies the pure water to the water electrolysis unit 12 and circulates excess water drained from the water electrolysis unit 12 back to the water electrolysis unit 12; a hydrogen-side gas-liquid separator 18 that removes moisture contained in the high pressure hydrogen generated by the water electrolysis unit 12; a hydrogen dehumidifier 20 that removes moisture contained in hydrogen supplied from the hydrogen-side gas-liquid separator 18 by absorption; and a controller (controller apparatus) 22.

The water electrolysis unit 12 includes a stack of unit cells 24. In addition, a terminal plate 26a, an insulating plate 28a and an end plate 30a are disposed in sequence at an end of the unit cells 24 in the stack direction in that order toward the outside. Similarly, a terminal plate 26b, an insulating plate 28b and an end plate 30b are disposed in sequence at the other end of the unit cells 24 in the stack direction in that order toward the outside. The unit cells 24 and those plates between the end plates 30a and 30b are clamped and held together.

Terminal portions 34a and 34b are provided on the sides of the terminal plates 26a and 26b, respectively, so as to project outward therefrom. The terminal portions 34a and 34b are electrically connected to an electrolysis power supply (direct current power supply) 38 by wires 36a and 36b, respectively.

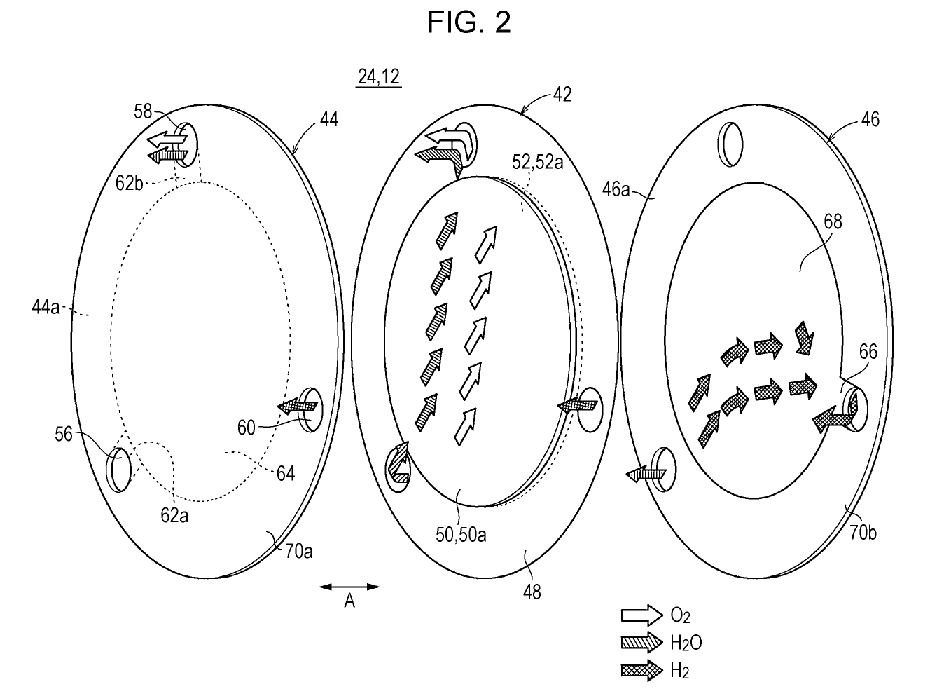

As illustrated in FIG. 2, the unit cell 24 includes a disk-shaped electrolyte membrane/electrode assembly 42 and an anode-side separator 44 and a cathode-side separator 46 which sandwich the electrolyte membrane/electrode assembly 42 therebetween. The anode-side separator 44 and the cathode-side separator 46 each have a disk shape and are formed from, for example, a carbon member or the like, or are formed by press-molding a steel plate, a stainless steel plate, a titanium plate, an aluminum plate, a plated steel plate or a metal plate subjected to anticorrosive surface treatment, or are formed by cutting followed by anticorrosive surface treatment.

The electrolyte membrane/electrode assembly 42 includes, for example, a solid polymer electrolyte membrane 48 including a perfluorosulfonic acid thin film impregnated with water, and an anode-side current collector 50 and a cathode-side current collector 52 provided on both surfaces of the solid polymer electrolyte membrane 48.

An anode electrode catalyst layer 50a and a cathode electrode catalyst layer 52a are formed on both surfaces of the solid polymer electrolyte membrane 48. The anode electrode catalyst layer 50a uses, for example, a Ru (ruthenium)-based catalyst while the cathode electrode catalyst layer 52a uses, for example, a platinum catalyst.

The anode-side current collector 50 and the cathode-side current collector 52 are formed from, for example, a sintered body (electrically conductive porous body) of spherically atomized titanium powder. The anode-side current collector 50 and the cathode-side current collector 52 are provided with a smooth surface portion subjected to etching treatment after grinding and have a porosity set in the range of 10% to 50%, preferably 20% to 40%.

In a circumferential portion of the unit cell 24, there are provided: a water supply communicating hole 56 for communicating with the other unit cells 24 to supply water (pure water) in the arrow direction A that is the stacking direction; a discharge communicating hole 58 for discharging oxygen generated by the reaction and spent water (mixed fluid); and a hydrogen communicating hole 60 for leading high pressure hydrogen generated by the reaction.

A supply path 62a communicating with the water supply communicating hole 56 and a discharge path 62b communicating with the discharge communicating hole 58 are provided in a surface 44a of the anode-side separator 44, the surface 44a facing the electrolyte member/electrode assembly 42. A first flow path (anode-side electrolysis chamber) 64 communicating with the supply path 62a and the discharge path 62b is provided in the surface 44a. The first flow path 64 is provided within a range corresponding to the surface area of the anode-side current collector 50 and formed from a plurality of flow path grooves, embosses, etc.

A discharge path 66 communicating with the hydrogen communicating hole 60 is provided in a surface 46a of the cathode-side separator 46, the surface 46a facing the electrolyte member/electrode assembly 42. A second flow path (cathode-side electrolysis chamber) 68 communicating with the discharge path 66 is provided in the surface 46a. The second flow path 68 is provided within a range corresponding to the surface area of the cathode-side current collector 52 and formed from a plurality of flow path grooves, embosses, etc.

Seal members 70a and 70b are integrally provided around the circumferential edges of the anode-side separator 44 and the cathode-side separator 46, respectively. The seal members 70a and 70b are formed using a seal material, a cushion material or a packing material made of, for example, EPDM (ethylene propylene diene), NBR (nitrile butadiene rubber), fluorocarbon rubber, silicone rubber, fluorosilicone rubber, butyl rubber, natural rubber, styrene rubber, chloroprene, acrylic rubber or the like.

As illustrated in FIG. 1, the water circulation unit 16 includes circulation piping 72 communicating with the water supply communicating holes 56 of the water electrolysis unit 12. The circulation piping 72 is provided with a circulation pump 74, an ion exchanger 76 and an oxygen-side gas-liquid separator 78.

One of the ends of return piping 80 communicates with the upper part of the oxygen-side gas-liquid separator 78, and the other end of the return piping 80 communicates with the discharge communicating holes 58 of the water electrolysis unit 12. Pure water supply piping 82 connected to the pure water supply unit 14 and oxygen exhaust piping 84 for discharging oxygen separated from pure water in the oxygen-side gas-liquid separator 78 are connected to the oxygen-side gas-liquid separator 78.

One of the ends of high pressure hydrogen piping 88 is connected to the hydrogen communicating holes 60 of the water electrolysis unit 12, and the other end of the high pressure hydrogen piping 88 is connected to the hydrogen-side gas-liquid separator 18. Pressure releasing piping 88a is branched out from the high pressure hydrogen piping 88 and provided with a pressure releasing valve 89.

The high pressure hydrogen, from which moisture is removed by the hydrogen-side gas-liquid separator 18, is dehumidified by the hydrogen dehumidifier 20. Dry hydrogen is then supplied to dry hydrogen piping 90. The dry hydrogen piping 90 is provided with a back pressure valve 91 and a check valve 92. The pressure of hydrogen generated in the hydrogen communicating holes 60 is held higher than that of the oxygen-side. The dry hydrogen piping 90 is also provided with a detachable filling nozzle 94 for a fuel cell electric vehicle (not illustrated in the figure). The filling nozzle 94 is provided with, which is not illustrated in the drawing, a sensor that detects whether or not the filling nozzle 94 is attached to a fuel cell electric vehicle.

Drain piping 96 is connected to the lower part of the hydrogen-side gas-liquid separator 18. The drain piping 96 is provided with a drain valve 98. The high pressure hydrogen piping 88 is provided with a first pressure sensor 100 that is disposed close to the hydrogen communicating holes 60 and detects the pressure (stack pressure) of the second flow path 68, which is the cathode-side electrolysis chamber. The dry hydrogen piping 90 is further provided with a second pressure sensor 102 that is disposed close to the downstream-side of the check valve 92 and detects the filling pressure of the dry hydrogen to be filled into a fuel tank disposed inside the fuel cell electric vehicle.

The controller 22 electrically connects to a user control panel 104. The user control panel 104 accepts user's operations such as ending of hydrogen filling, start-up of water electrolysis operation, refilling of hydrogen during the course of pressure releasing, etc., and sends corresponding signals to the controller 22.

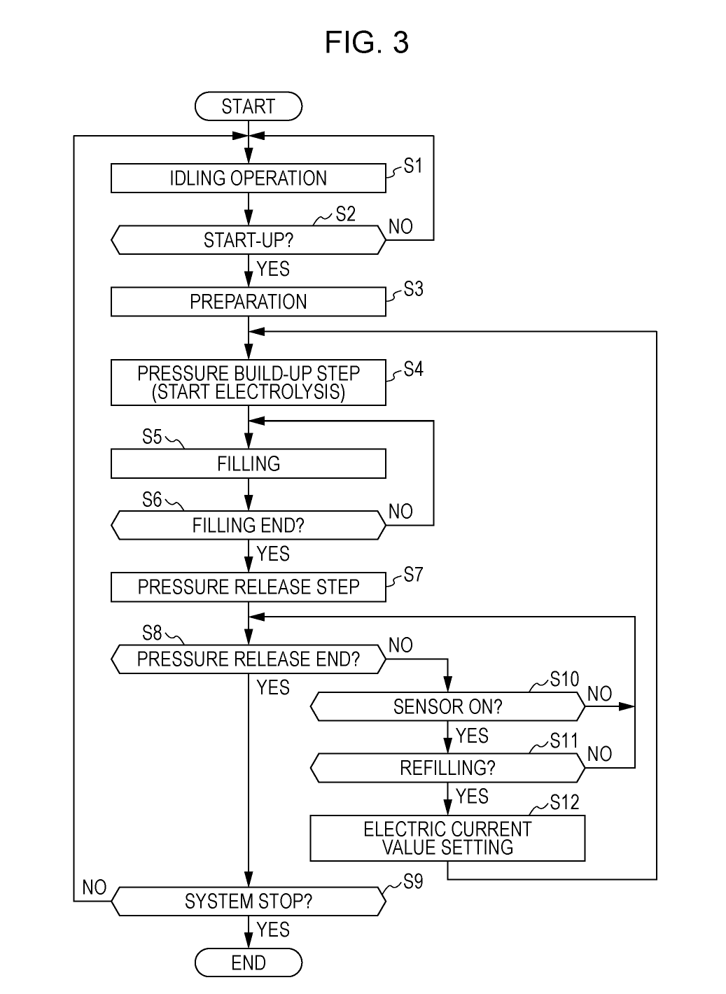

An operation method of the differential pressure water electrolysis apparatus 10 configured as above is now described with reference to a flow chart of FIG. 3.

First, when a system main switch is turned on to power the differential pressure water electrolysis apparatus 10, an idling operation starts (Step S1). During the idling operation, a fan, etc. are activated. When the differential pressure water electrolysis apparatus 10 is started up (YES at Step S2), the operation flow proceeds to Step S3 that is a preparation step. In Step S3, pure water is generated by the pure water supply unit 14 from tap water, and the pure water generated is supplied to the hydrogen-side gas-liquid separator 78 included in the water circulation unit 16.

Next, the operation flow proceeds to Step S4 that is a pressure build-up step where the electrolysis of water starts. Specifically, in the water circulation unit 16, pure water is supplied to the water supply communicating holes 56 of the water electrolysis unit 12 through the circulation piping 72 under the operation of the circulating pump 74. On the other hand, an electrolysis voltage is applied across the terminal portions 34a and 34b of the terminal plates 26a and 26b by the electrolysis power supply 38 electrically connected thereto.

Accordingly, as illustrated in FIG. 2, in each of the unit cells 24, the water is supplied to the first flow path 64 of the anode-side separator 44 from the water supply communicating holes 56, and the water moves along the anode-side current collector 50.

Therefore, the water is electrically decomposed at the anode electrode catalyst layer 50a, and hydrogen ions, electrons and oxygen are generated. The hydrogen ions generated by an anodic reaction permeate through the solid polymer electrolyte membrane 48, move to the cathode electrode catalyst layer 52a, and combine with electrons to generate hydrogen.

As a result, the hydrogen flows along the second flow path 68 formed between the cathode-side separator 46 and the cathode-side current collector 52. The hydrogen is held under a pressure higher than that in the water supply communicating holes 56 and can be taken out to the outside of the water electrolysis unit 12 through the hydrogen communicating holes 60.

On the other hand, oxygen generated by the reaction and spent water are mixed and flow through the first flow path 64, and this mixed fluid is discharged to the return piping 80 of the water circulation unit 16 through the discharge communicating holes 58 (refer to FIG. 1). The spent water and oxygen are introduced into the oxygen-side gas-liquid separator 78 and subjected to gas-liquid separation. Then, water is introduced into the water supply communicating holes 56 from the circulation piping 72 through the circulating pump 74 and the ion exchanger 76. Oxygen separated from the water is discharged to the outside through the oxygen exhaust piping 84.

The hydrogen generated from the water electrolysis unit 12 is sent to the hydrogen-side gas-liquid separator 18 through the high pressure hydrogen piping 88. In the hydrogen-side gas-liquid separator 18, moisture contained in the hydrogen is separated therefrom. Furthermore, the hydrogen is dehumidified by the hydrogen dehumidifier 20. The pressure of hydrogen is increased up to a preset pressure of the back pressure valve 91.

When the filling nozzle 94 is attached to a fuel cell electric vehicle, the dry hydrogen is supplied through the dry hydrogen piping 90 to fill up the fuel tank of the fuel cell electric vehicle (Step S5). A filling status (filling pressure) of the fuel tank is detected by the second pressure sensor 102. When the filling status reaches to a desired status (YES at Step S6), the filling ends and the operation flow proceeds to the pressure release step (Step S7).

During the pressure release step, the electrolysis power supply 38 applies a voltage lower than the electrolysis voltage described above. The applying voltage may be set in the range of 0.2 V to 0.8 V, preferably 0.2 V to 0.5 V. Accordingly, the controller 22 controls the electrolysis power supply 38 so that each of the unit cells 24 included in the water electrolysis unit 12 constantly receives a set voltage of, for example, 0.5 V or less. With the condition described above, the pressure releasing of the cathode-side high pressure hydrogen starts.

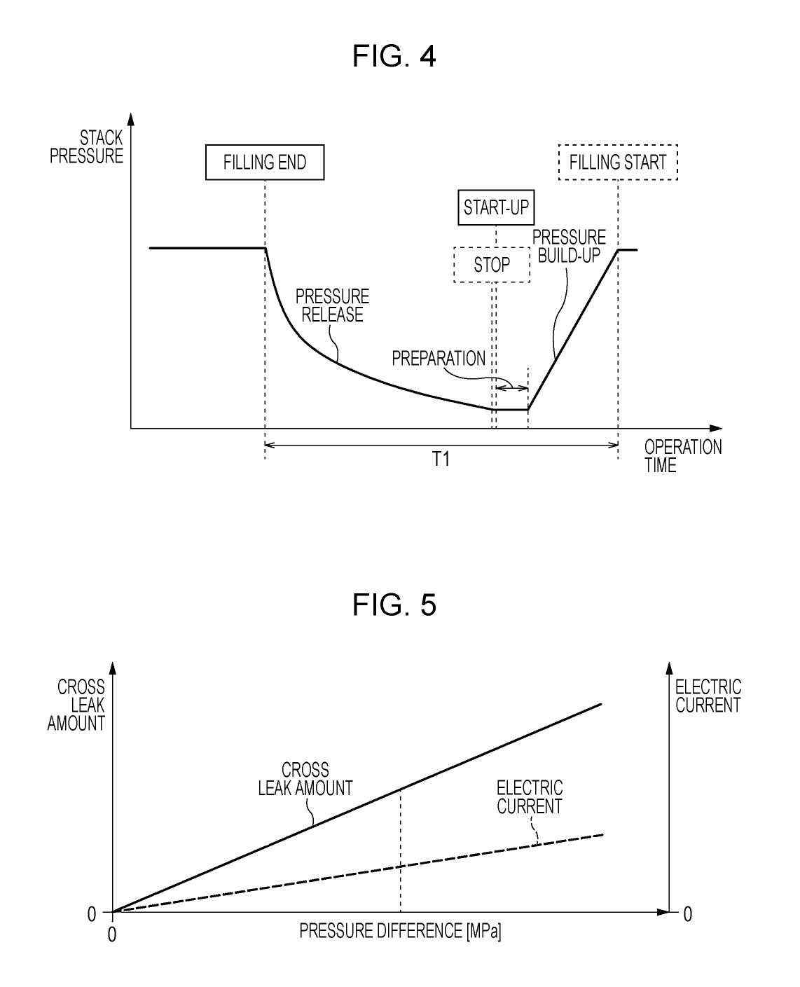

Specifically, the pressure releasing valve 89 is opened so that the pressure releasing piping 88a communicates with the hydrogen communicating holes 60. Accordingly, the high pressure hydrogen filling the second flow path 68 that is the cathode-side electrolysis chamber is released slowly for pressure reduction in response to the adjustment of opening of the pressure releasing valve 89 (see FIG. 4).

The applying of the voltage by the electrolysis power supply 38 stops when the hydrogen pressure inside the second flow path 68 becomes equal to the pressure (normal pressure) of the first flow path 64. That stops the operation of the differential pressure water electrolysis apparatus 10, concluding the pressure release step (YES at Step S8). The control ends when the system is stopped (YES at Step S9) and the system main switch is turned off. When the system is not stopped (NO at Step S9), the operation flow returns to Step S1.

On the other hand, during the pressure releasing (NO at Step S8), if it is determined that the filling nozzle 94 is attached to the fuel cell electric vehicle (or another fuel cell electric vehicle) (YES at Step S10), the operation flow proceeds to Step S11. When a user turns on a start switch for hydrogen refilling at Step S11 (YES at Step S11), the operation flow proceeds to Step S12 and the value of an electric current is set.

In the present embodiment, values of an electric current required for the electrolysis of water are calculated in advance in response to pressures of the second flow path 68 that is the cathode-side electrolysis chamber. Specifically, as illustrated in FIG. 5, the amount of hydrogen cross-leaking from the cathode-side electrolysis chamber to the anode-side electrolysis chamber increases as the pressure difference between the second flow path 68 and the first flow path 64 (normal pressure) increases.

Accordingly, the value of an electric current that can reduce the cross-leaking from the cathode-side electrolysis chamber to the anode-side electrolysis chamber increases as the pressure difference increases. Suitable values of an electric current are calculated in advance in response to the pressure differences.

As described above, the controller 22 calculates in advance values of an electric current required for the electrolysis of water in response to pressures of the second flow path 68, and detects the pressure of the second flow path 68 by the first pressure sensor 100 when the electrolysis of water is not carried out. When a user turns on the start switch for refilling hydrogen, the value of an electric current is set to a value equal to or larger than the value which is calculated in advance and corresponds to the pressure (that is the pressure difference) detected at the second flow path 68.

Subsequently, the operation flow returns from Step S12 to Step S4. At Step S4, the value of an electric current is set as described above when the pressure build-up step starts. As a result, the cross-leaking from the second flow path (cathode-side electrolysis chamber) 68 to the first flow path (anode-side electrolysis chamber) 64 may be reduced reliably.

Accordingly, waste of hydrogen due to the cross-leak may be suitably reduced particularly at the time of start-up the differential pressure water electrolysis apparatus 10 in which the pressure is being released. In this manner, there is an advantage such that rapid and effective electrolysis of water may be carried out even when there is a pressure difference between the anode-side and the cathode-side.

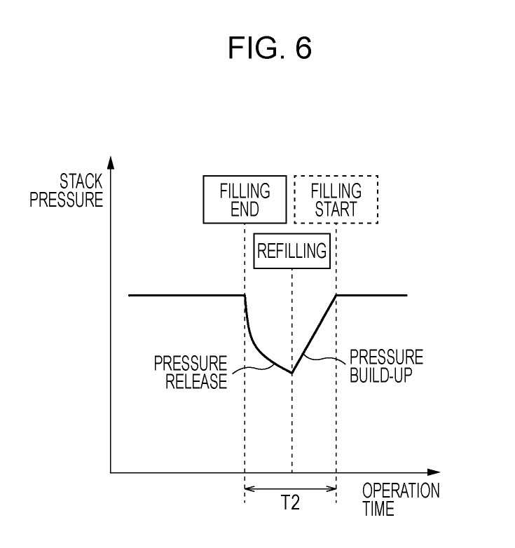

Furthermore in the present embodiment, as illustrated in FIG. 6, the pressure is being build-up after stopping the pressure releasing during the course of the pressure release step. Accordingly, the time until the filling (T2 in FIG. 6) is markedly reduced (T1>T2) compared to that in a typical case (T1 in FIG. 4) in which the steps of the pressure release, preparation and pressure build-up are carried out. Accordingly, there are advantages such that the time until the filling is markedly reduced; the operation is more user-friendly; and the electric power consumption of equipment may be easily cut down.

The embodiment of the present invention provides a method for operating a differential pressure water electrolysis apparatus in which an electrolyte membrane is provided with current collectors at both sides thereof and an electrolysis voltage is applied between the current collectors to generate oxygen at an anode-side electrolysis chamber and hydrogen with a pressure higher than a normal pressure at a cathode-side electrolysis chamber by electrolysis of water.

The method includes: calculating in advance values of an electric current required for the electrolysis of water in response to pressures of the cathode-side electrolysis chamber; detecting a pressure of the cathode-side electrolysis chamber when the electrolysis of water is not carried out; determining whether or not the electrolysis of water is to be started; and starting the electrolysis of water with an electric current having a value equal to or higher than the value which is calculated in advance and corresponds to a detected pressure of the cathode-side electrolysis chamber when it is determined that the electrolysis of water is to be started.

In the method, it is preferable that the detecting and subsequent operations are carried out during a period when the pressure of the cathode-side electrolysis chamber is being released.

According to the embodiment of the present invention, the electric current is set to a value equal to or higher than the value required to carry out the electrolysis of water in response to the pressure of the cathode-side electrolysis chamber when there is a pressure difference between the cathode-side electrolysis chamber and the anode-side electrolysis chamber. As a result, hydrogen cross-leaking from the cathode-side electrolysis chamber to the anode-side electrolysis chamber may be reduced reliably.

Accordingly, waste of hydrogen due to the cross-leaking may be suitably reduced particularly at the time of start-up of the differential pressure water electrolysis apparatus in which the pressure is being released. In this manner, the electrolysis of water may be carried out rapidly and effectively even when there is a pressure difference between the anode-side and the cathode-side.

Obviously, numerous modifications and variations of the present invention are possible in light of the above teachings. It is therefore to be understood that within the scope of the appended claims, the invention may be practiced otherwise than as specifically described herein.

What is claimed is:

1. A method for operating a differential pressure water electrolysis apparatus in which an electrolyte membrane is provided with current collectors at both sides of the electrolyte membrane and in which an electrolysis voltage is applied between the current collectors to generate oxygen at an anode-side electrolysis chamber and hydrogen with a pressure higher than a normal pressure at a cathode-side electrolysis chamber by electrolysis of water, the method comprising:
calculating in advance values of an electric current required for the electrolysis of water in response to pressures of the cathode-side electrolysis chamber;
detecting a pressure of the cathode-side electrolysis chamber when the electrolysis of water is not carried out;
determining whether or not the electrolysis of water is to be started; and
starting the electrolysis of water with an electric current having a value equal to or higher than a value which is calculated in advance in the calculating of the values of the electric current and which corresponds to a detected pressure of the cathode-side electrolysis chamber when it is determined that the electrolysis of water is to be started.

2. The method according to claim 1, wherein
the detecting and subsequent operations are carried out during a period when the pressure of the cathode-side electrolysis chamber is being released.

3. The method according to claim 1, wherein
the detecting of the pressure of the cathode-side electrolysis chamber, and the determining of the electrolysis of water are carried out during a period when the pressure of the cathode-side electrolysis chamber is being released.

4. The method according to claim 1, wherein
in the determining of the electrolysis of water, it is determined that the electrolysis of water is to be started when a user turns on a start switch for hydrogen refilling.
